(19) United States
(12) Patent Application Publication
(10) Pub. No.: US 2010/0023953 A1
(43) Pub. Date: Jan. 28, 2010

(54) METHOD AND APPARATUS FOR EXECUTING APPLICATION

(75) Inventors: Hyun-chul LEE, Suwon-si (KR); Hwa-kyung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronic Co., Ltd., Suwon-si (KR)

(21) Appl. No.: 12/402,684

(22) Filed: Mar. 12, 2009

(30) Foreign Application Priority Data
Jul. 25, 2008 (KR) 10-2008-0072953

(51) Int. Cl. G06F 9/54; G06F 17/20

(52) U.S. Cl. 719/328; 715/234

(57) ABSTRACT

Provided are a method and apparatus for executing a web application, the method including receiving a predetermined application program interface (API) set from an external device in which APIs are stored, parsing and storing the received API set, and executing the web application by using at least one of APIs included in the parsed API set.

### CROSS-REFERENCE TO RELATED PATENT APPLICATION

This application claims the benefit of Korean Patent Application No. 10-2008-0072953, filed on Jul. 25, 2008, in the Korean Intellectual Property Office, the disclosure of which is incorporated herein in its entirety by reference.

### BACKGROUND OF THE INVENTION

1. Field of the Invention

The present invention relates to a method and an apparatus for executing an application, and more particularly, to a method and an apparatus for executing a web application.

2. Description of the Related Art

Due to developments in networking technologies, various kinds of information can easily be obtained at home nowadays, and efficiencies of web applications have been significantly improved. A web application is an application receiving data via a network, processing the received data, and providing information desired by a user. Examples of web applications include web browsers or web widgets. A user can easily obtain desired information via a web browser or a web widget.

Meanwhile, most web pages that a user accesses by using a web browser are embodied by using either codes written in hyper text makeup language (HTML) or codes written in HTML and JavaScript. However, a web page embodied by using codes written in only HTML has various limitations in design and function. To overcome the limitations, an application program interface (API) written by using JavaScript is executed, and a result of processing codes written in HTML and a result of executing the API are output together.

To execute an API written by using the JavaScript, a web page creator may include codes written in JavaScript directly within codes written in HTML. Furthermore, in the case of a frequently used API whose codes are open to the public, codes written in JavaScript may be stored in an external server so that the codes may be received and used if required. In this case, a web browser receives codes written in JavaScript, parses the received codes, executes the parsed codes, and outputs a result of execution.

### SUMMARY OF THE INVENTION

The present invention provides a method and an apparatus for executing an application.

According to an aspect of the present invention, there is provided a method of executing a web application comprising receiving a predetermined application program interface (API) set from an external device in which APIs are stored; parsing and storing the received API set; and executing the web application by using at least one of APIs included in the parsed API set.

The web application may be a web browser, and the reception of the predetermined API set may comprise receiving an API set recorded in an API reception list within the web browser when the web browser is executed.

The execution of the web application may comprise receiving a signal requesting access to a first web page; and determining whether a first API required for outputting the first web page is included in the API set or not.

The method may further comprise performing at least one of adding a new API set to the API reception list and deleting/modifying API sets recorded in the API reception list to be received.

The web application may be a web browser, the first API used for outputting the first web page may be stored at a first time point in the storing of the received API set, and a second web page may be output by using the first API if a signal requesting access to the second web page is received at a second time point in the executing of the web application.

The storage of the received API set may comprise determining whether a flag instructing to store the first API is included in a HTML document required for outputting the first web page or not; and selectively storing the first API according to a result of the determination.

The web application may be a widget application, and the receiving of the predetermined API set may comprise receiving an API set recorded in an API reception list within a widget engine, which manages the widget application, when the widget engine is executed.

The API set may comprise at least one API written in JavaScript.

According to another aspect of the present invention, there is provided an apparatus for executing a web application, the apparatus comprising a reception unit receiving a predetermined API set from an external device in which APIs are stored; a storage unit parsing and storing the received API set; and an execution unit executing the web application by using at least one of APIs included in the parsed API set.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus 100 for executing an application, according to an exemplary embodiment of the present invention;

FIG. 2 is a flowchart of a method of executing a web application according to an exemplary embodiment of the present invention;

FIG. 3 is a block diagram showing an example of an apparatus for executing a web application providing service according to the method of FIG. 2;

FIG. 4 is a flowchart of a method of executing a web application according to another exemplary embodiment of the present invention;

FIG. 5 is a diagram showing operations of an apparatus for executing web application providing service according to the method of FIG. 4;

FIG. 6 is a diagram showing operations of an apparatus for executing a web application according to another exemplary embodiment of the present invention; and

FIG. 7 is a flowchart of a method of executing a web application according to an exemplary embodiment of the present invention.

### DETAILED DESCRIPTION OF EXEMPLARY EMBODIMENTS

Exemplary embodiments of the present invention will now be described with reference to the attached drawings.

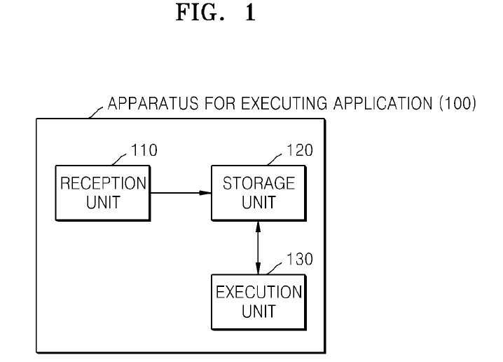

FIG. 1 is a block diagram of an apparatus 100 for executing an application, according to an exemplary embodiment of the present invention.

The apparatus 100 includes a reception unit 110, a storage unit 120, and an execution unit 130. Here, a web application is a general term for applications receiving data via networks, processing the received data, and providing information desired by users. Examples of web applications include web browsers or web widgets. For convenience of explanation, an exemplary embodiment of the present invention will be described below with respect to a web browser. However, the present invention is not limited thereto, and the present invention may be applied to other web applications such as widget applications.

The reception unit 110 receives a predetermined application program interface (API) set from an external device in which APIs are stored. An API may be written in various programming languages, and more particularly, an API may be written in JavaScript.

The storage unit 120 parses and stores the received API set. The storage unit 120 may include a parsing unit (not shown) and a storage determination unit (not shown).

The parsing unit parses the received API set. Here, the parsing operation indicates all operations required for converting the format of a received API set to a format instantly usable by a web browser. For example, the parsing operation may include interpretation or compilation.

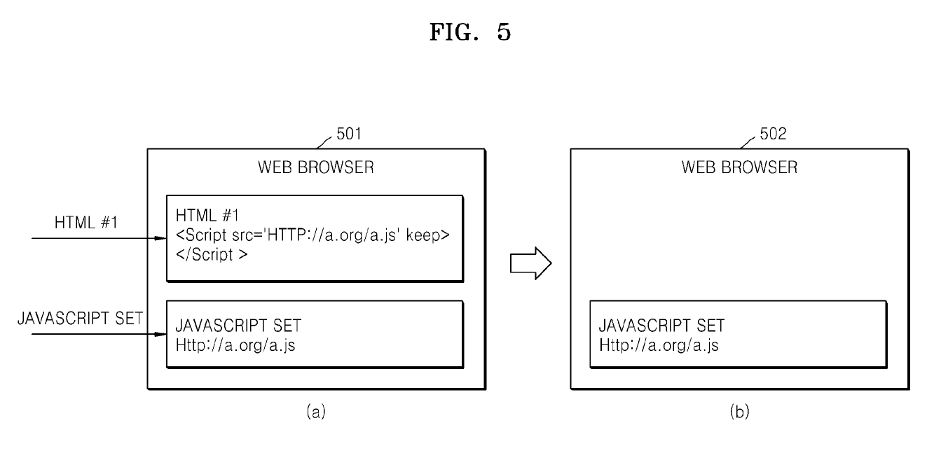

The storage determination unit determines whether to store a received API set or not. According to embodiments, only part of APIs in an API set may be stored, and determination whether to store APIs or not may be made according to a predetermined flag. Detailed description thereof will be given below by referring to FIG. 5.

The execution unit 130 executes a web application by using at least one of APIs included in the parsed API set. The execution unit 130 may include a signal reception unit (not shown) and a determination unit (not shown).

The signal reception unit receives a request to receive an API required for providing a web page requested by a user. A user can request access to a desired web page by using a method such as typing the address of a web page to access into an address window. For convenience of explanation, a web page that a user attempts to access will be hereinafter referred as a first web page.

The determination unit determines whether an API required for providing a first web page is stored in the storage unit 120.

Hereinafter, operations of the components both in a case where an API set recorded in an API reception list is received at the same time as a web browser is executed and in a case where a predetermined API set is received after a web browser has been executed and access to a particular website has already been gained will be described.

First, operations of the components in the case where an API set recorded in an API reception list is received at the same time as a web browser is executed will be described below.

When a user launches a web browser, the reception unit 110 confirms types and locations of API sets recorded in an API reception list and receives an API set. Commonly used API sets or API sets used in a website the user frequently accesses may be recorded in the API reception list. The user may add a new API set to the API reception list. Furthermore, the user may delete or modify API sets recorded in the API reception list. The apparatus 100 may further include a reception list management unit (not shown). According to an input from the user, the reception list management unit may either add API sets to the API reception list or delete and modify API sets in the API reception list.

When API sets recorded in the API reception list are received, the storage unit 120 parses and stores the received API sets.

When a web browser is executed, the user types the address of the first web page into an address window of the web browser.

When the user inputs the address of the first web page, the web browser receives an HTML document corresponding to the input address and parses the HTML document. In the case where an API is linked to the parsed HTML document, the API is required to be executed and a result of the execution is required to be output with the HTML document.

The signal reception unit (not shown) within the execution unit 130 receives a signal requesting reception of the API linked to the HTML document, and the determination unit within the execution unit 130 determines whether the linked API is included in the API set stored in the storage unit 120 or not.

In the case where the linked API is included in the API set stored in the storage unit 120, the required API is searched for in the API set and the found API is executed. Since the API sets are parsed in advance, the linked API can be executed quickly. The execution unit 130 outputs a result of executing the linked API. The result of executing the linked API is output together with a result of parsing the HTML document corresponding to the first web page.

In contrast, in the case where the linked API is not included in the API set stored in the storage unit 120, the reception unit 110 is required to receive an API required for outputting the first web page from an external server and the parsing unit parses the received API.

Next, operations of the components in the case where a predetermined API set is received after a web browser has been executed and access to a particular website has already been obtained will be described below.

A user launches a web browser. Even if the user launches the web browser, the reception unit 110 does not receive API sets at this point.

Next, when the user types the address of the first web page into an address window, the web browser receives and parses a HTML document corresponding to the first web page. When an API is linked to the received HTML document, the reception unit 110 receives the linked API from an external server.

When APIs are received at the reception unit 110, the storage unit 120 parses and stores the received APIs. At this point, the storage unit 120 may store all of the received APIs or may selectively store APIs having a possibility of being used in the future only from among the received APIs. A web page creator may include a flag instructing storage of APIs in a HTML document.

The storage determination unit within the storage unit 120 determines whether to store a received API or not. The storage unit 120 selectively stores the API according to a result of determination of the storage determination unit. Detailed description thereof will be given below in reference to FIG. 5.

Afterward, if a user requests a web browser to move to a second web page from the first web page by typing the address of the second web page into the address window, a HTML document corresponding to the first web page is deleted. However, linked APIs may not be deleted and may be continuously stored in the storage unit 120.

When a user requests to move to a second web page, a web browser receives and parses a HTML document required for outputting the second web page. When an API is linked to the HTML document required for outputting the second web page, the determination unit of the execution unit 130 determines whether the linked API is stored in the storage unit 120 or not. In the case where the linked API is stored in the storage unit 120, the API can be executed quickly without performing a parsing operation separately. The execution unit 130 outputs a result of executing the linked API. The result of executing the linked API is output together with a result of parsing a HTML document corresponding to the second web page.

Although the descriptions above are given with respect to a case in which a web application is a web browser, the present invention can also be applied to a case where the web application is an application other than a web browser; i.e. a widget application.

In the case of a widget application, widget applications distributed by the same creator use the same APIs in most cases. When a user launches a widget engine which manages widget applications, the reception unit 110 receives API sets recorded in an API reception list in the widget engine. The storage unit 120 parses and stores the received API sets. Then, when the user launches a particular widget application, the execution unit 130 determines whether an API required for executing the user's desired widget application is stored in the storage unit 120 or not. If the API is stored in the storage unit 120, the API can be executed without separately performing a parsing operation. Thus, the user's desired widget application can be executed quickly.

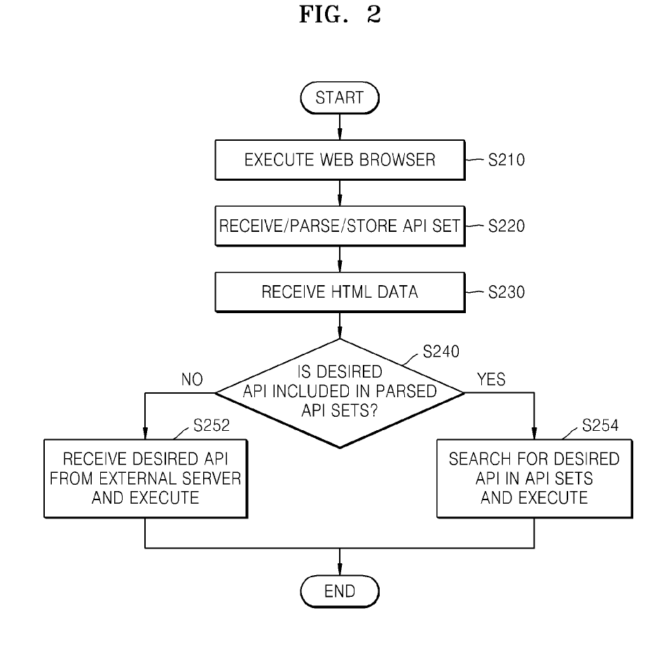

FIG. 2 is a flowchart of a method of executing a web application according to an exemplary embodiment of the present invention. Referring to FIG. 2, execution of a web browser will be described as an example of the method of executing a web application according to the present invention.

In operation S210, a web browser is executed in response to an input of a user. The user can execute a web browser by double-clicking an icon corresponding to the web browser in a consumer electronics (CE) device such as a computer.

In operation S220, an API set recorded in an API reception list is received, the received API set is parsed, and the parsed API set is stored. The API reception list can be stored in the web browser and managed. The user can add, delete, and modify types of API sets to be received and addresses from which API sets can be received by modifying the API reception list.

In operation S230, when the user types the address of a first web page to access in an address window, codes, which are written in HTML, corresponding to the web page are received. Hereinafter, codes written in HTML will be referred to as an HTML document for convenience of explanation.

In operation S240, it is determined whether a first API, which is an API required for providing the first web page, is included in the parsed API set or not.

In the case where the first API is included in the parsed API set, the method proceeds to operation S254. In operation S254, the first API is searched in the parsed API set and is executed. Since it requires no separate parsing operation, time required for loading a web page can be reduced.

In the case where the first API is not included in the parsed API set, the method proceeds to operation S252. In operation S252, the first API is received from an external server and is executed. The first API received in operation S252 can be parsed and stored. In this case, if the first API needs to be executed in a web page accessed later, the first API parsed in advance can be used.

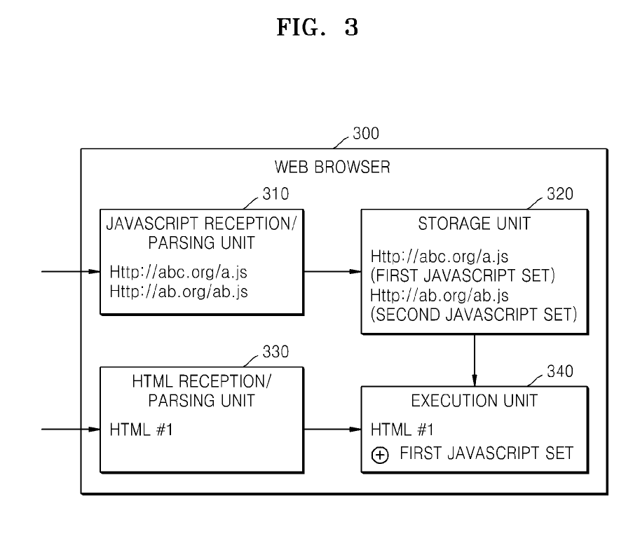

FIG. 3 is a block diagram showing an example of an apparatus for executing a web application providing service according to the method of FIG. 2. In FIG. 3, it is assumed that the apparatus for executing a web application is a web browser 300.

The web browser 300 according to an exemplary embodiment of the present invention includes a JavaScript reception/parsing unit 310, a storage unit 320, a HTML reception/parsing unit 330, and an execution unit 340.

The JavaScript reception/parsing unit 310 receives and parses API sets. API sets may be written in the JavaScript language, and may be received from an external server storing API sets. According to the present invention, the JavaScript reception/parsing unit 310 receives and parses API sets recorded in an API reception list simultaneously as the web browser 300 is executed.

The storage unit 320 stores the parsed API sets.

The HTML reception/parsing unit 330 receives and parses a HTML document corresponding to the first web page. The first web page refers to a web page the user desires to access. In the case where an API written in JavaScript is linked to the HTML document, the HTML reception/parsing unit 330 control the execution unit to receive and execute the linked API.

The execution unit 340 executes the linked API and displays a result of executing the linked API together with the HTML document corresponding to the first web page. In the case where the linked API is stored in the storage unit 320, the linked API is executed. In the case where the linked API is not stored in the storage unit 320, the execution unit 340 control the JavaScript reception/parsing unit 310 to receive the linked API.

Hereinafter, operations of the web browser 300 according to an exemplary embodiment of the present invention will be described in chronological order.

First, when a user executes the web browser 300 to browse a web page, the JavaScript reception/parsing unit 310 receives API sets recorded in the API reception list. The user can modify types of API sets recorded in the API reception list by using a method such as changing preference settings of the web browser 300, etc. According to the illustrated embodiment, an API set named ‘a.js’ and an API set named ‘b.js’ are recorded in the API reception list, and the API sets are written in JavaScript. Therefore, the JavaScript reception/parsing unit 310 receives and parses the ‘a.js’ and the ‘b.js’ and transmits them to the storage unit 320.

The storage unit 320 stores the ‘a.js’ and the ‘b.js’, which are parsed.

Then, the user types the address of the first web page into an address window. The HTML reception/parsing unit 330 receives and parses a HTML document corresponding to the first web page from a web server operating the first web page.

The execution unit 340 receives the parsed HTML document from the HTML reception/parsing unit 330 and displays the first web page by using the parsed HTML document. At this point, if an API is linked to the HTML document corresponding to the first web page, the execution unit 340 is required to display a result of parsing the HTML document together with a result of executing the linked API.

Therefore, the execution unit 340 determines whether the linked API is stored in the storage unit 320. In other words, it is determined whether the linked API is included in the ‘a.js’ or the ‘b.js’ or not. If the linked API is stored in the storage unit 320, the execution unit 340 receives the linked API from the storage unit 320 and executes the linked API. If the linked API is not stored in the storage unit 320, the execution unit 340 controls the JavaScript reception/parsing unit 310 to receive the linked API from an external server.

According to the exemplary embodiment of the present invention shown in FIG. 3, frequently used API sets are parsed and stored at the same time as a web browser is executed, and thus time required for loading a web page can be reduced. Especially, in the case where the same API is repeatedly used in a plurality of web pages, the API has to be parsed only once.

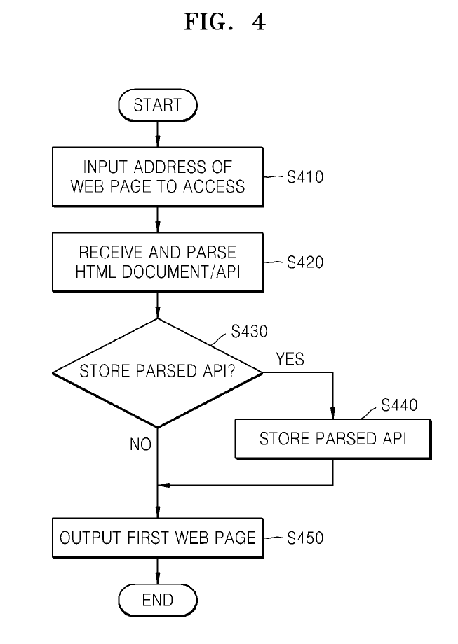

FIG. 4 is a flowchart of a method of executing a web application according to another exemplary embodiment of the present invention. In FIG. 4, it is assumed that the web application is a web browser.

In operation S410, the address of a first web page a user desires to access is received.

In operation S420, a HTML document corresponding to the first web page is received and parsed. If an API is linked to the HTML document, the API is received and parsed.

In operation S430, it is determined whether to store the parsed API or not. To indicate whether to store the parsed API or not, a separate flag may be added to the HTML document. Detailed description thereof will be given later in reference with FIG. 5. In the case where it is determined to store the parsed API, the method proceeds to operation S440. In operation S440, the parsed API is stored.

In operation S450, the first web page is output by using the HTML document and the API that are parsed in operation S420.

FIG. 5 is a diagram showing operations of an apparatus for executing a web application providing service according to the method of FIG. 4. In FIG. 5, it is assumed that the apparatuses for executing web applications are web browsers 501 and 502.

When a user inputs the address of a first web page to access, the web browser 501 receives a HTML document corresponding to the first web page. It is assumed that an API is linked to the received HTML document and the API is written in JavaScript. Referring to FIG. 5, the HTML document corresponding to the first web page is indicated as HTML #1, and an API set ‘a.js’ is linked to the HTML #1. Furthermore, the API set ‘a.js’ can be received from ‘http://a.org/ajs’. The web browser 501 receives the API set ‘ajs’ from ‘http://a.org/a.js’ and parses the same. The web browser 501 displays the first web page by using the parsed HTML document HTML #1 and the parsed API set ‘ajs’.

An HTML document may include a flag indicating whether to store parsed API or not. For example, additional properties may be defined in an HTML tag as shown in FIG. 5.

Referring to FIG. 5, the HTML document includes a tag <script src=‘HTTP://a.org/a.js’, keep></script>. The ‘keep’ property indicates that the API needs to be stored. Thus, the web browser 501 parses and stores the ‘ajs.’

Thereafter, when the user types new address into an address window of the web browser 502, the web browser 502 deletes the HTML #1 and receives an HTML document corresponding to the new address. However, the ‘a.js’ which is previously received and parsed is not deleted and is instead kept stored. Thus, in the case where the ‘a.js’ is linked to the HTML document corresponding to the new address, it is not necessary to receive and parse the API set again and the API set previously parsed can be used instantly.

In the case where web sites are operated by the same business, the same API set is often linked to different web pages. Conventionally, this situation has been very inefficient because the API set has to be repeatedly received and parsed even in the case mentioned above. However, according to the present invention, a separate property is given to HTML tags such that frequently used API sets are stored. Thus, the problem of repeated receiving and parsing of the same API set is resolved, and the time required for loading a web page can be significantly reduced.

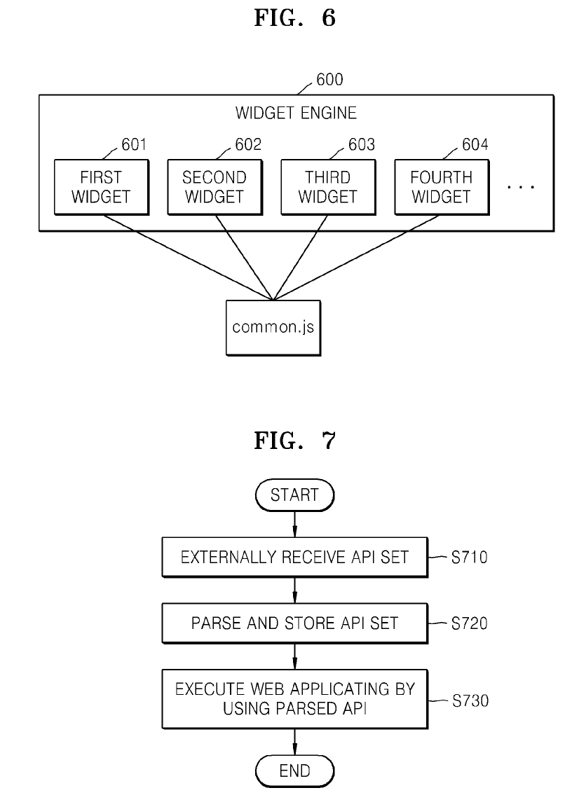

FIG. 6 is a diagram showing operations of an apparatus for executing a web application according to another exemplary embodiment of the present invention. In FIG. 6, the apparatus for executing a web application is a widget engine 600. The widget engine 600 functions as a management unit adding/deleting widgets and functions as an interface between widgets and an operating system (OS). In FIG. 6, the widget engine 600 manages first through fourth widgets 601 through 604.

When a user executes the widget engine 600, the widget engine 600 receives API sets registered in advance. The user may register new API sets or delete registered API sets by changing preference settings. The received API sets are parsed and stored, and the widget applications 601 through 604 may use them later.

When the user attempts to execute the first widget 601, the first widget 601 determines whether an API required for the execution is included in parsed API sets or not. In the case where the API required for the execution is included in the parsed API sets, the first widget 601 is executed by using the API.

In an alternative embodiment, API sets used for executing widget applications such as the first widget 601 may be stored after the widget applications are executed, rather than parsing and storing API sets when the widget engine is executed.

In most cases, widget applications created and distributed by the same company use the same APIs. Conventionally, this situation has been inefficient because APIs have to be received and parsed every time a widget application is executed. However, according to the present invention, API sets that are likely to be used in common are parsed and stored in advance, and thus it is more efficient than the prior art.

FIG. 7 is a flowchart of a method of executing a web application according to an exemplary embodiment of the present invention. A web application is a general term for applications receiving data via networks, processing the received data, and providing information desired by users.

In operation S710, a predetermined API set is received from an external device in which APIs are stored. In an alternative embodiment, an API reception list may be prepared within a web application such that desired API sets are received at the same time as the web application is executed. A user can add API sets to the API reception list or delete/modify API sets recorded in the API reception list.

In operation S720, the received API set is parsed and stored.

In operation S730, a web application is executed by using at least one of APIs included in the parsed API set.

The embodiments of the present invention can be written as computer programs and can be implemented in general-use digital computers that execute the programs using computer readable codes on a computer readable recording medium or a computer readable transmission medium. Examples of the computer readable recording medium include magnetic storage media (e.g., ROM, floppy disks, hard disks, etc.), optical recording media (e.g., CD-ROMs, or DVDs). Examples of the computer readable transmission medium include carrier waves (e.g., transmission through the Internet).

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of executing a web application comprising:
receiving a predetermined application program interface (API) set from an external device in which APIs are stored;
parsing and storing the received API set in a computer readable recording medium; and
executing the web application by using at least one API included in the parsed API set.

2. The method of claim 1, wherein the web application is a web browser, and the receiving of the predetermined API set comprises receiving an API set recorded in an API reception list within the web browser when the web browser is executed.

3. The method of claim 2, wherein the executing of the web application comprises:
receiving a signal requesting access to a first web page; and
determining whether a first API required for outputting the first web page is included in the API set.

4. The method of claim 2, further comprising performing at least one of adding a new API set to the API reception list and deleting or modifying an API set recorded in the API reception list to be received.

5. The method of claim 1, wherein the web application is a web browser, a first API used for outputting a first web page is stored at a first time point in the storing of the received API set, and a second web page is output by using the first API if a signal requesting access to the second web page is received at a second time point in the executing of the web application.

6. The method of claim 5, wherein the storing of the received API set comprises:
determining whether a flag instructing to store the first API is included in a HTML document required for outputting the first web page; and
selectively storing the first API according to a result of the determining.

7. The method of claim 1, wherein the web application is a widget application, and the receiving of the predetermined API set comprises receiving an API set recorded in an API reception list within a widget engine, which manages the widget application, when the widget engine is executed.

8. The method of claim 1, wherein the API set comprises at least one API written in JavaScript.

9. An apparatus for executing a web application, the apparatus comprising:
a reception unit receiving a predetermined API set from an external device in which APIs are stored;
a storage unit parsing and storing the received API set in a computer readable recording medium; and
an execution unit executing the web application by using at least one API included in the parsed API set.

10. The apparatus of claim 9, wherein the web application is a web browser, and the reception unit receives an API set recorded in an API reception list within the web browser when the web browser is executed.

11. The apparatus of claim 10, wherein the execution unit comprises:
a signal reception unit receiving a signal requesting access to a first web page; and
a determination unit determining whether a first API required for outputting the first web page is included in the API set.

12. The apparatus of claim 10, further comprising a reception list management unit performing at least one of adding a new API set to the API reception list and deleting or modifying an API set recorded in the API reception list.

13. The apparatus of claim 9, wherein the web application is a web browser, the storage unit stores a first API used for outputting a first web page at a first time point, and the execution unit comprises a display unit that displays a second web page by using the first API if a signal requesting access to the second web page is received at a second time point.

14. The apparatus of claim 13, further comprising a determination unit determining whether a flag instructing to store the API is included in a HTML document required for outputting the first web page,
wherein the storage unit selectively stores the first API according to a result of the determining.

15. The apparatus of claim 9, wherein the application is a widget application, and the reception unit receives an API set recorded in an API reception list within a widget engine, which manages the widget application, when the widget engine is executed.

16. The apparatus of claim 9, wherein the API set comprises at least one API set written in JavaScript.

17. A computer readable recording medium having recorded thereon a computer program including computer instructions for enabling a computer executing the instructions to perform a method for executing a web application, the method comprising:
receiving a predetermined application program interface (API) set from an external device in which APIs are stored;
parsing and storing the received API set in a computer readable recording medium; and
executing the web application by using at least one API included in the parsed API set.

18. A method for executing web content, comprising:
executing a web application for executing web content;
receiving at least one application programming interface (API) of an API set from an external device in which APIs are stored;
parsing and storing the at least one received API of the API set in a computer readable recording medium;
after the storing of the at least one parsed API, receiving, by the web application, a command to execute a first web content; and
executing, by the web application, the first web content by using at least one parsed API of the API set stored in the computer readable medium.

19. The method of claim 18, further comprising:
prior to the receiving, parsing and storing of the at least one API, receiving, by the web application, a command to execute a second web content requiring one or more APIs for execution;
wherein said API set comprises the one or more APIs required to execute the second web content.

20. The method of claim 18, wherein the APIs of the API set are recorded in a API list prior to the execution of the web application.

21. The method of claim 18, wherein the APIs of the API set are recorded in a API list prior to the execution of the web application.

22. The method of claim 18, wherein the web application is a widget engine for managing at least one widget application and the first web content is a first widget application managed by the widget engine.

23. The method of claim 18, wherein the web application is a web browser and the first web content is a first web page.
